(19) United States
(12) Patent Application Publication
(10) Pub. No.: US 2023/0234077 A1
(43) Pub. Date: Jul. 27, 2023

(54) MULTI-STREAM HOLLOW-CONE NOZZLE

(71) Applicant: Aero Pump GmbH, Hochheim/Main (DE)

(72) Inventors: Sebastian ROTHER, Mainz (DE); Milena Angelika MARSZALEK, Mainz (DE)

(73) Assignee: Aero Pump GmbH, Hochheim/Main (DE)

(21) Appl. No.: 18/101,309

(22) Filed: Jan. 25, 2023

(30) Foreign Application Priority Data
Jan. 26, 2022 (DE) 10 2022 101 750.8

(51) Int. Cl. B05B 1/06; B05B 1/18

(52) U.S. Cl. CPC B05B 1/06; B05B 1/185; B33Y 80/00

(57) ABSTRACT

A nozzle body and a method of forming the nozzle body. The nozzle body includes at least two hollow-cone nozzle geometries. The nozzle body includes an injection molded or a 3D printed thermoplastic material.

### CROSS-REFERENCE TO RELATED APPLICATION

This application claims priority under 35 U.S.C. § 119(a) to German Application No. 10 2022 101 750.8 filed Jan. 26, 2022, the disclosure of which is expressly incorporated by reference herein in its entirety.

### BACKGROUND

### 1. Field of the Invention

Embodiments are directed to a nozzle body that is produced from thermoplastic material by an injection molding process or 3D printing process. Furthermore, embodiments relate to a method for producing a nozzle body.

### 2. Discussion of Background Information

In an injection molding process, plastic is pressed into a mold so that, with the injection molding process, a host of different geometries are producible, which geometries are subject to some limitations. Thus, a diameter of cavity-shaped geometries has a lower limit, for example. Furthermore, undercuts, for example, can only be realized to a limited extent in the scope of the injection molding process.

A 3D printing process is an additive manufacturing process in which material is applied layer-by-layer so that a three-dimensional form results. The 3D printing process is thereby subject to some limitations, as a consequence of which the design freedom is limited.

Due to the limitations of the injection molding process or the 3D printing process, the design of a nozzle body is limited, so that it is also only possible to produce certain geometries. Accordingly, characteristics of the spray mist that is to be generated by the nozzle body are limited.

### SUMMARY

Embodiments are directed to a nozzle body with which a large design freedom of the spray mist that is to be generated is enabled.

The nozzle body can include at least two hollow-cone nozzle geometries. Each hollow-cone nozzle geometry respectively may include a turbulence chamber and a hole, which is also known as a “nozzle bore.” In the turbulence chamber, a fluid that is to be atomized is set in rotation so that the fluid passes out of the nozzle body through the nozzle bore, thereby generating a spray cone. Depending upon the arrangement of the hollow-cone nozzle geometries, the at least two spray cones can at least partially overlap. Moreover, with the at least two hollow-cone nozzle geometries, multiple spray cones can be generated so that a voluminous, full spray mist can be generated. As a result of the at least two spray cones that generate the spray mist, a surface area of the droplets of the spray mist is, in an equal discharge, greater overall than in a discharge of the same amount with only a single spray cone. Furthermore, a spray pattern can be adapted through the arrangement of the hollow-cone nozzle geometries. Thus, the spray pattern can be designed to be fuller, softer, or broader, for example. Furthermore, through the use of multiple hollow-cone nozzle geometries, an actuating force can be reduced since a throughput of the fluid as a whole occurs through multiple hollow-cone nozzle geometries.

Preferably, at least one of the hollow-cone nozzle geometries is asymmetrical. A nozzle bore of the asymmetrical hollow-cone nozzle geometry is thus arranged in an eccentric, that is, off-center, manner in relation to the turbulence chamber, for example. The term “asymmetrical” thereby means not rotationally symmetrical. Because of the asymmetrical design of at least one hollow-cone nozzle geometry, a characteristic of the spray mist can be controlled in a targeted manner.

Preferably, a nozzle bore of the asymmetrical hollow-cone nozzle geometry has a longitudinal axis at an angle<90°, preferably greater than or equal to 50° and less than or equal to 88°, particularly preferably greater than or equal to 70° and less than or equal to 87°, to a nozzle outlet surface. The nozzle outlet surface corresponds to a surface through which the fluid passes to the outside during the discharge. As a result, a very broad overall spray mist, for example, can be generated depending on the arrangement of individual hollow-cone nozzle geometries. Accordingly, a characteristic of the spray mist that is to be generated can be influenced by adapting the angle.

Preferably, the hollow-cone nozzle geometries respectively comprise a nozzle bore which has a diameter≤300 μm, preferably ≤200 μm, particularly preferably ≤100 μm. With correspondingly small nozzle bores, a spray mist with correspondingly small droplets can be generated.

Preferably, the at least two hollow-cone nozzle geometries are arranged symmetrically with one another. Thus, the hollow-cone nozzle geometries can be arranged, for example, in point symmetry, rotational symmetry, or mirror symmetry with one another, so that a uniform spray mist can be generated.

Preferably, the nozzle body comprises a material having at least one principal component from the group PMMA (poly(methyl methacrylate)), POM (polyoxymethylene), PP (polypropylene), PE (polyethylene). ABS (acrylonitrile-butadiene-styrene copolymer), COC (cycloolefin copolymer), PA (polyamide), PC (polycarbonate), PBT (poly(butylene terephthalate)), PEEK (poly(ether ether ketone)), PEI (polyetherimide), PET (poly(ethylene terephthalate)), and PPE (poly(phenylene ether)). These materials would belong to the group of thermoplastic materials and can be easily processed, alone or in combination, using injection molding processes or 3D printing processes. A combination is, for example, a mixture of PE and PP.

Preferably, the at least two hollow-cone nozzle geometries are at least partially produced by a laser processing. The at least partial laser processing can thereby use, for example, methods of laser ablation, laser drilling, or 3D laser ablation. Laser ablation refers to the removal of material from a surface through bombardment by a pulsed laser. The laser or the laser radiation thereby leads to a rapid heating and, consequently, the formation of a plasma on the surface of the workpiece. Laser drilling is likewise a non-cutting processing method in which, by laser radiation, so much energy is introduced into the workpiece that the material is fused and partially evaporated. 3D laser ablation is a special configuration of laser ablation in which material is processed in three dimensions. Furthermore, a combination of the stated methods is possible, for example. For instance, with the at least partial laser processing, it is possible to generate only a single geometry of the hollow-cone nozzle geometries. Alternatively, it is also possible to produce the entire hollow-cone nozzle geometries using the laser processing. This results in a large design freedom and a large flexibility.

Embodiments are directed to a method that includes producing the nozzle body using an injection molding process or 3D printing process, and at least partially creating at least two hollow-cone nozzle geometries by laser processing.

With the laser processing, the hollow-cone nozzle geometries can be designed or created in a flexible manner. Furthermore, with the laser processing, geometries, such as undercuts for example, are possible, which geometries cannot be produced, or can only be produced to a limited extent, using an injection molding process or 3D printing process. As a result, a spray mist that is generated by the hollow-cone nozzle geometries of the nozzle body can be influenced in a targeted manner. This influencing is achieved through an adaptation of the hollow-cone nozzle geometries, which can be easily adapted by the laser processing.

Preferably, the laser processing uses methods of laser ablation, laser drilling, and/or 3D laser ablation. In laser ablation, material is removed from a surface through bombardment with a pulsed laser beam or pulsed laser radiation. In laser drilling, so much energy is locally introduced into the workpiece by laser radiation that the material is locally fused and partially evaporated. A fusing of the material at the edge of the bore is thereby not desired. Likewise feasible, for example, is a combination of the stated methods. As a result, a good design freedom of the hollow-cone nozzle geometry or of the nozzle body is achieved.

Preferably, the laser processing produces at least one asymmetrical hollow-cone nozzle geometry. The term “asymmetrical” thereby refers to an arrangement in which a nozzle bore of the hollow-cone nozzle geometry is arranged off-center, that is, eccentrically, from the turbulence chamber. Accordingly, the hollow-cone nozzle geometry is not rotationally symmetrical. The term “asymmetrical” means not rotationally symmetrical. As a result of this arrangement, a spray cone of the asymmetrical hollow-cone nozzle geometry can be adapted to corresponding specifications, so that a very broad overall spray mist can be generated, for example.

Preferably, the laser processing creates a nozzle bore of the asymmetrical nozzle geometry with an axis at an angle<90°, preferably greater than or equal to 50° and less than or equal to 88°, particularly preferably greater than or equal to 70° and less than or equal to 87°, to an outlet surface. An overlap of the spray cones can thus be adapted so that a characteristic of the overall spray mist can be influenced.

Preferably, the laser processing respectively produces a nozzle bore of the hollow-cone nozzle geometries with a diameter≤300 μm, preferably ≤200 μm, particularly preferably ≤100 μm. The laser processing is an efficient and flexible way of producing nozzle bores with the stated diameters. Furthermore, with the laser processing, an adaptation of the nozzle bore diameter can easily be realized. It is thus possible to flexibly respond to new requirements.

Preferably, the at least two hollow-cone nozzle geometries are created such that they are symmetrical with one another. With the symmetrical arrangement of the hollow-cone nozzle geometries, a symmetrical spray mist can be generated. Fluid droplets are distributed within the spray mist in a correspondingly uniform manner.

Preferably, the injection molding process or the 3D printing process uses a material having at least one principal component from the group PMMA (poly(methyl methacrylate)), POM (polyoxymethylene), PP (polypropylene), PE (polyethylene), ABS (acrylonitrile-butadiene-styrene copolymer), COC (cycloolefin copolymer), PA (polyamide), PC (polycarbonate), PBT (poly(butylene terephthalate)), PEEK (poly(ether ether ketone)), PEI (polyetherimide), PET (poly(ethylene terephthalate)), and PPE (poly(phenylene ether)). The injection molding process or the 3D printing process with the use of plastic is a common method that constitutes a cost-efficient way of producing nozzle bodies from one or more plastics. Thus, the nozzle body can, for example, be produced from a single material or from a combination or mixture of various stated materials. An example of a mixture of PE and PP.

Embodiments are directed to a nozzle body that includes at least two hollow-cone nozzle geometries. The nozzle body includes an injection molded or a 3D printed thermoplastic material.

According to embodiments, at least one of the hollow-cone nozzle geometries can be asymmetrical. Further, a nozzle bore of the at least one asymmetrical hollow-cone nozzle geometries can have a longitudinal axis oriented at an angle less than 90° to a nozzle outlet surface. Moreover, the longitudinal axis is oriented at an angle that is: greater than or equal to 50° and less than or equal to 88° to the nozzle outlet surface; or greater than or equal to 70° and less than or equal to 87° to a nozzle outlet surface. Still further, at least one of the hollow-cone nozzle geometries can be symmetrical and can include a nozzle bore having a longitudinal axis oriented perpendicular to the nozzle outlet surface.

In accordance with embodiments, the at least two hollow-cone nozzle geometries may each include a nozzle bore having a diameter less than or equal to 300 μm. Further, each nozzle bore can have a diameter that is: less than or equal to 200 μm; or less than or equal to 100 μm.

In embodiments, the at least two hollow-cone nozzle geometries may be arranged symmetrically with one another.

According to other embodiments, the injection molded or a 3D printed thermoplastic material can include a material having at least one principal component from the group PMMA, POM, PP, PE, ABS, COC, PA. PC. PBT. PEEK, PEI, PET, and/or PPE.

In other embodiments, the at least two hollow-cone nozzle geometries may be at least partially produced by a laser processing.

Embodiments are directed to a method that includes forming the nozzle body from a thermoplastic material in one of an injection molding process or a 3D printing process; and at least partially creating at least two hollow-cone nozzle geometries by laser processing.

According to embodiments, the laser processing may include at least one of laser ablation, laser drilling, and/or 3D laser ablation.

In accordance with other embodiments, via the laser processing, the at least two hollow-cone nozzle geometries may include at least one asymmetrical hollow-cone nozzle geometry. Further, the method can also include creating a nozzle bore via the laser for the at least one asymmetrical hollow-cone nozzle geometry having a longitudinal axis oriented at an angle less than 90° to an outlet surface. Moreover, the longitudinal axis can be oriented at an angle that is: greater than or equal to 50° and less than or equal to 88° to the nozzle outlet surface; or greater than or equal to 70° and less than or equal to 870 to a nozzle outlet surface. Still further, via the laser processing, the at least two hollow-cone nozzle geometries may further include at least one symmetrical hollow-cone nozzle geometry having a nozzle bore created via the laser with a longitudinal axis oriented perpendicular to the outlet surface.

In accordance with embodiments, the method may include producing, via the laser processing, a nozzle bore for each of the at least two hollow-cone nozzle geometries with a diameter less than or equal to 300 μm. Each nozzle bore can have a diameter that is: less than or equal to 200 μm; or less than or equal to 100 μm.

In other embodiments, the at least two hollow-cone nozzle geometries may be created to be symmetrical with one another.

In accordance with still yet other embodiments, a thermoplastic material in one of an injection molding process or a 3D printing process may include a material having at least one principal component from the group PMMA, POM, PP, PE, ABS, COC, PA, PC, PBT, PEEK, PEI, PET, and/or PPE.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic top view of a nozzle body of a first exemplary embodiment,

FIG. 2 shows a schematic sectional view of a nozzle body of the first exemplary embodiment,

FIG. 3 shows a schematic top view of a nozzle body of a second exemplary embodiment,

FIG. 4 shows a schematic sectional view of a nozzle body of the second exemplary embodiment,

FIG. 5 shows a schematic sectional illustration of an asymmetrical hollow-cone nozzle geometry,

FIG. 6 shows a schematic sectional illustration of a symmetrical hollow-cone nozzle geometry.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

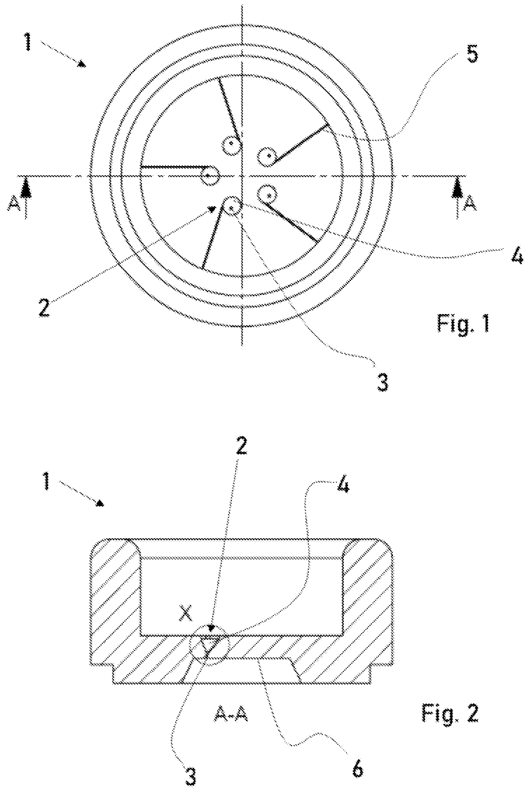

FIG. 1 shows a nozzle body 1 with five asymmetrical hollow-cone nozzle geometries 2 which respectively comprise a nozzle bore 3 and a turbulence chamber 4. The asymmetrical hollow-cone nozzle geometries 2 are respectively connected to a turbulence channel 5. In FIG. 1, a sectional plane A-A is furthermore illustrated which simultaneously represents a plane of symmetry of the hollow-cone nozzle geometry arrangement.

Identical elements are labeled with the same reference numerals, regardless of the exemplary embodiment.

FIG. 2 shows a sectional view of the nozzle body 1 illustrated in FIG. 1 along section plane A-A. The asymmetrical hollow-cone nozzle geometry 2 shown is arranged such that it is essentially oblique to a nozzle outlet surface 6.

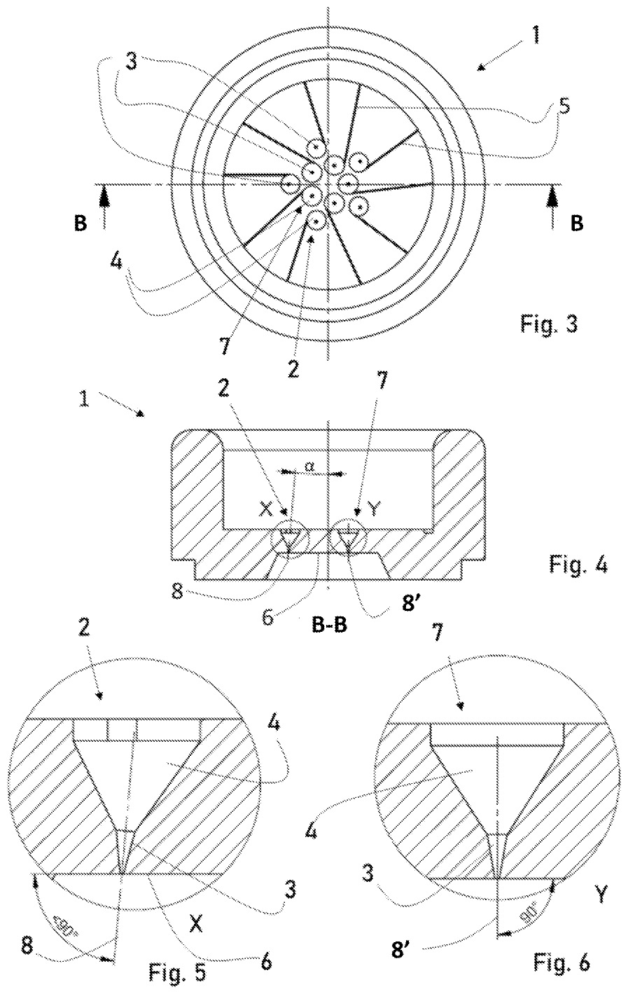

FIG. 3 shows a second exemplary embodiment of the nozzle body 1 with asymmetrical hollow-cone nozzle geometries 2 and symmetrical hollow-cone nozzle geometries 7. The arrangement of the hollow-cone nozzle geometries 2, 7 is symmetrical with the sectional plane or plane of symmetry B-B, e.g., in point symmetry, rotational symmetry or mirror symmetry. Each of the hollow-cone nozzle geometries 2, 7 respectively comprises a turbulence chamber 4 and a nozzle bore 3. Furthermore, each of the hollow-cone nozzle geometries 2, 7 is respectively connected to one turbulence channel 5.

FIG. 4 shows the second exemplary embodiment of the nozzle body 1 along the sectional plane B-B. A longitudinal axis 8 of the nozzle bore 3 of the asymmetrical hollow-cone nozzle geometry 2 has an angle α to a perpendicular line of nozzle outlet surface 6. The longitudinal axis 8′ of the symmetrical hollow-cone nozzle geometry 7 is arranged parallel to the perpendicular line of the outlet surface 6.

FIG. 5 shows the detailed portion of the asymmetrical hollow-cone nozzle geometries 2 in FIG. 4. The longitudinal axis 8 of the nozzle bore 3 thereby has an angle of <90° relative to the nozzle outlet surface 6. In addition to the nozzle bore 3, the asymmetrical hollow-cone nozzle geometry 2 also comprises the turbulence chamber 5. The turbulence chamber 5 thereby has an asymmetrical cone geometry. In this description, asymmetrical means not rotationally symmetrical. However, other symmetries, such as a mirror symmetry for example, are possible.

FIG. 6 shows the detailed portion of the symmetrical hollow-cone nozzle geometry 7 in FIG. 4. The symmetrical hollow-cone nozzle geometry comprises a turbulence chamber 5 and a nozzle bore 3, wherein the nozzle bore 3 has a longitudinal axis which is arranged perpendicularly to the outlet surface 6.

The nozzle body 1 comprises thermoplastic material as a principal component, preferably at least one of PMMA (poly(methyl methacrylate)), POM (polyoxymethylene), PP (polypropylene), PE (polyethylene), ABS (acrylonitrile-butadiene-styrene copolymer), COC (cycloolefin copolymer). PA (polyamide), PC (polycarbonate), PBT (poly(butylene terephthalate)), PEEK (poly(ether ether ketone)), PEC (polyetherimide), PET (poly(ethylene terephthalate)), and/or PPE (poly(phenylene ether)). The plastic is processed to form the nozzle body 1 by an injection molding process or a 3D printing process, and the hollow-cone nozzle geometries 2, 7 are then created by laser processing, e.g., via at least one of laser ablation, laser drilling, and/or 3D laser ablation.

With the laser processing, nozzle bores 3 with diameters≤300 μm, preferably ≤200 μm, and particularly preferably ≤100 μm can be produced. These dimensions refer to the smallest diameter of the nozzle bore 3.

The longitudinal axis 8 of the asymmetrical hollow-cone nozzle geometry 2 has an angle<90° to the outlet surface 6, and a preferred angle of 85°. Accordingly, as illustrated in FIG. 4, the longitudinal axis 8 of the asymmetrical hollow-cone nozzle geometry 2 is inclined by the angle α to a perpendicular line of the outlet surface 6. In the present exemplary embodiment, the angle α is 5° so that the longitudinal axis 8 of the asymmetrical hollow-cone nozzle geometry 2 has an angle of 85° to the nozzle outlet surface 6. Alternative angles lie, for example, in the range of greater than or equal to 50° and less than or equal to 88°, or alternatively, for example, in the range of greater than or equal to 70° and less than or equal to 87°, in reference to the outlet surface 6.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMERALS

1 Nozzle body
2 Asymmetrical hollow-cone nozzle geometry
3 Nozzle bore
4 Turbulence chamber
5 Turbulence channel
6 Nozzle outlet surface
7 Symmetrical hollow-cone nozzle geometry
8 Longitudinal axis of the nozzle bore of the asymmetrical hollow-cone nozzle geometry
8′ Longitudinal axis of the nozzle bore of the symmetrical hollow-cone nozzle geometry

1. A nozzle body comprising:
at least two hollow-cone nozzle geometries,
wherein the nozzle body comprises an injection molded or a 3D printed thermoplastic material.

2. The nozzle body according to claim 1, wherein at least one of the hollow-cone nozzle geometries is asymmetrical.

3. The nozzle body according to claim 2, wherein a nozzle bore of the at least one asymmetrical hollow-cone nozzle geometries has a longitudinal axis oriented at an angle less than 90° to a nozzle outlet surface.

4. The nozzle body according to claim 2, wherein the longitudinal axis is oriented at an angle that is:
greater than or equal to 500 and less than or equal to 88° to the nozzle outlet surface; or
greater than or equal to 700 and less than or equal to 870 to a nozzle outlet surface.

5. The nozzle body according to claim 1, wherein the at least two hollow-cone nozzle geometries each comprise a nozzle bore having a diameter less than or equal to 300 μm.

6. The nozzle body according to claim 5, wherein each nozzle bore has a diameter that is:
less than or equal to 200 μm; or
less than or equal to 100 μm.

7. The nozzle body according to claim 1, wherein the at least two hollow-cone nozzle geometries are arranged symmetrically with one another.

8. The nozzle body according to claim 1, wherein the injection molded or a 3D printed thermoplastic material comprises a material having at least one principal component from the group PMMA, POM, PP, PE, ABS, COC, PA, PC, PBT, PEEK, PEI, PET, and/or PPE.

9. The nozzle body according to claim 1, wherein the at least two hollow-cone nozzle geometries are at least partially produced by a laser processing.

10. The nozzle body according to claim 3, wherein at least one of the hollow-cone nozzle geometries is symmetrical and includes a nozzle bore having a longitudinal axis oriented perpendicular to the nozzle outlet surface.

11. A method for producing the nozzle body according to claim 1, the method comprising:
forming the nozzle body from a thermoplastic material in one of an injection molding process or a 3D printing process; and
at least partially creating at least two hollow-cone nozzle geometries by laser processing.

12. The method according to claim 11, wherein the laser processing comprises at least one of laser ablation, laser drilling, and/or 3D laser ablation.

13. The method according to claim 11, wherein, via the laser processing, the at least two hollow-cone nozzle geometries comprise at least one asymmetrical hollow-cone nozzle geometry.

14. The method according to claim 13, further comprising creating a nozzle bore via the laser for the at least one asymmetrical hollow-cone nozzle geometry having a longitudinal axis oriented at an angle less than 90° to an outlet surface.

15. The method according to claim 13, wherein the longitudinal axis is oriented at an angle that is:
greater than or equal to 500 and less than or equal to 88° to the nozzle outlet surface; or
greater than or equal to 70° and less than or equal to 870 to a nozzle outlet surface.

16. The method according to claim 11, further comprising producing, via the laser processing, a nozzle bore for each of the at least two hollow-cone nozzle geometries with a diameter less than or equal to 300 μm.

17. The method according to claim 16, wherein each nozzle bore has a diameter that is:
less than or equal to 200 μm; or
less than or equal to 100 μm.

18. The method according to claim 11, wherein the at least two hollow-cone nozzle geometries are created to be symmetrical with one another.

19. The method according to claim 11, wherein a thermoplastic material in one of an injection molding process or a 3D printing process comprises a material having at least one principal component from the group PMMA, POM, PP, PE, ABS, COC, PA, PC, PBT, PEEK, PEI, PET, and/or PPE.

20. The method according to claim 13, wherein, via the laser processing, the at least two hollow-cone nozzle geometries further comprise at least one symmetrical hollow-cone nozzle geometry having a nozzle bore created via the laser with a longitudinal axis oriented perpendicular to the outlet surface.
